(19) United States
(12) Patent Application Publication
(10) Pub. No.: US 2005/0080721 A1
(43) Pub. Date: Apr. 14, 2005

(54) Automated financial transaction due diligence systems and methods

(76) Inventors: Victor Paul Kearney, Zephyr Cove, NV (US); Richard L. Collins, El Dorado Hills, CA (US); Chris Scheuble, Sacramento, CA (US)

Correspondence Address: LELAND K. JORDAN, 1235 THUNDER HILL ROAD, LINCOLN UNIVERSITY, PA, 19352, US

(21) Appl. No.: 10/962,836

(22) Filed: Oct. 12, 2004

Related U.S. Application Data
(60) Provisional application No. 60/510,363, filed on Oct. 9, 2003.

(51) Int. Cl. G06F 17/60

(52) U.S. Cl. 705/38; 705/39

(57) ABSTRACT

Financial transaction and due diligence management convergence platforms, systems, methods and articles of manufacture to retrieve, analyze, validate and communicate a community of users' data records (or workspace templates). Specifically, methods for real time managing of information and records related to users' content created, edited, modified and housed in unique, disparate or federated holdings in centralized or distributed environments.

This application derives from and claims the benefit of U.S. Provisional Patent Application No. 60/510363, filed Oct. 9, 2003, which is hereby incorporated by reference in its entirety.

### FIELD OF THE INVENTION

The present invention provides financial transaction and due diligence management convergence platforms, systems, and methods to retrieve, analyze, validate and communicate a community of users' data records (or workspace templates). More specifically, the present invention provides methods for real time managing of information and records related to users' content created, edited and housed in unique, disparate or federated holdings in centralized or distributed environments. The present invention also provides systems and methods for creating and managing records using domain specific language, vocabulary, metadata, metadata schema, jargon, and combinations or derivatives thereof, accepted by a community of users of unique, disparate or federated databases in centralized or distributed environments.

### BACKGROUND OF THE INVENTION

Financial and transaction due diligence professionals such as asset based lenders, real estate brokers, financial brokers, stock brokers, mortgage brokers, banks, title insurance agents, attorneys, patent agents and examiners, title search firms, corporate investment departments, technology transfer managers, and the like, have the need to perform laborious tasks of searching for, retrieving, analyzing, validating and communicating various forms of financial transaction information. Such financial transactions include: mortgages, real estate sales, technology transfer and other types of investments.

Known subscription-based and non-subscription-based search and processing systems only provide due diligence professionals with basic search and retrieval functions. Database hardware and software have been developed for access by due diligence professionals and other users through personal computers, mainframes, and other processor-based devices. Users may access and view due diligence information stored locally on CD-ROMs, stored on network storage devices through a local area network, or stored on remote database systems through one or more disparate network paths (e.g., the Internet).

Electronic searching processing and validation (collectively “due diligence”) for financial transaction information is quickly becoming the preferred searching vehicle given the vast amount of information available, the complexity of the information, the geographical limitations posed, and the technical adeptness of the majority of due diligence professionals. The known electronic searching and validation systems, however, provide nothing more than rudimentary searching functions that require the due diligence professionals to formulate the content and direction of their validation strategy through previous experience or trial-and-error. The systems are unable to facilitate or fully automate the creation of search queries and criteria. Nor do the known systems provide for the efficient retrieval, retention, organization and communication of due diligence information sought or resulting from the searching and validation process.

Ignat, et al., in U.S. Pat. No. 6,611,838 discloses a method of managing metadata via a metadata exchange platform that allows for a synchronization of databases.

Armatis et al., in U.S. Pat. No. 6,697,822 discloses a method to update data files using metadata consisting of unique record identifiers.

Boothby el al., in U.S. Pat. No. 5,684,990 and Pet el al., in U.S. Pat. No. 5,835,912 discloses methods to synchronize update and transfer data and data records of disparate databases.

Noble el al., in U.S. Pat. No. 5,634,053 discloses a method to create a virtual centralized database of a plurality of interconnected local databases.

Dockter et al., in U.S. Pat. No. 5,678,038 discloses the use of database schemas for the management of classification systems.

Lau et al., in U.S. Pat. No. 6,502,098 discloses of transferring data using data table hierarchy.

Lebda et al, in U.S. Pat. No. 6,611,816 discloses a personal loan processing methodology for communicating between a borrower and lender.

Norris, in U.S. Pat. No. 6,105,007 discloses a closed, kiosk closed loop system for automatic processing of loans.

To further complicate the environment that the prior art fails in, the current marketplace is inundated with proprietary legacy systems, expensive technology and a plethora of point products as outlined in the prior art cited. With regard to specific content housed in a plurality of unique, disparate or federated database environments, the prior art fails in that technologies are directed towards content or a mixture of content and metadata requiring dramatic usage of memory space, personnel inputting time and expensive equipment. Prior art systems such as learning content management systems (LCMS), document management systems or content management systems (CMS) all relate to content itself and the content is housed or synchronized in a centralized site.

Communications for the due diligence professional is a series of point-to-point interfaces. Currently, due diligence professionals are limited to a paper-based system where documents are communicated via regular land mail, faxes, and courier services. Such paper-based communications cause the majority of delays and errors in the financial transaction due diligence process. The current process today is complex, lengthy and costly with 4-6 billion new pages of information per year created in the financial transaction due diligence process.

The present invention provides for interoperability, convergence and increases the utilization of user content that financial information is related to. Embodiments of the present invention provide convergence platforms, systems and methods that are based on standards that are relevant to the users providing context to their jobs, organizations and processes.

### SUMMARY OF THE INVENTION

An embodiment of the present invention discloses a method to provide a financial transaction due diligence convergence platform comprising the steps of:
validating users' credentials;
validating permissions based upon the type of transaction and the role of the users; validating rules based upon the transaction profile and status;
creating a workspace template for transaction;
delivering the template to the users.

A another embodiment of the present invention provides said delivering step in formats such as real time user accessible databases, repositories, digital archives, analog archives or digital holdings.

Yet another embodiment of the present invention discloses the financial transaction being selected from a group consisting of, but not limited to: asset based lenders, personal loans, real estate loans, mortgages, insurance policies, appraisals, stock trades; auctions, and derivatives and combinations thereof.

Quality control of financial information output is now an important process that the prior art does not fully address. A further embodiment of the present invention provides for quality control processes that can include but is not limited to review, edit modification, security screening, privacy, filtering and other document control or access control measures.

Another embodiment of the present invention discloses a method to provide a financial transaction due diligence convergence platform comprising the steps of:
creating at least one set of user credentials for validating users;
validating at least one user;
establishing at least one set of permissions based upon the type of ransaction and the role of the users;
establishing at least on set of rules based upon the transaction profile and status;
creating at least one validated user workspace template of the transaction;
allowing users to access the at least one validated user workspace template.

Using such methods of the present invention provides a method for a user to economically and quickly poll (or search) created, accepted workspace templates and modify or edit said templates in a real time, online environment.

Still further, another embodiment of the present invention is an apparatus for and a method of searching, organizing and validating financial information in a due diligence is provided. An apparatus (and corresponding method) is provided for formulating and facilitating searches (including clarifications or requests) for financial information. Then organizing and validating results of such searches or requests.

### BRIEF DESCRIPTION OF DRAWINGS

FIG. 1 illustrates a system architecture in accordance with a embodiment of the invention related to investor transaction processing;

FIG. 2 illustrates a system architecture in accordance with a embodiment of the invention related to lender transaction processing;

FIG. 3 illustrates a system architecture in accordance with a embodiment of the invention related to mortgage transaction processing;

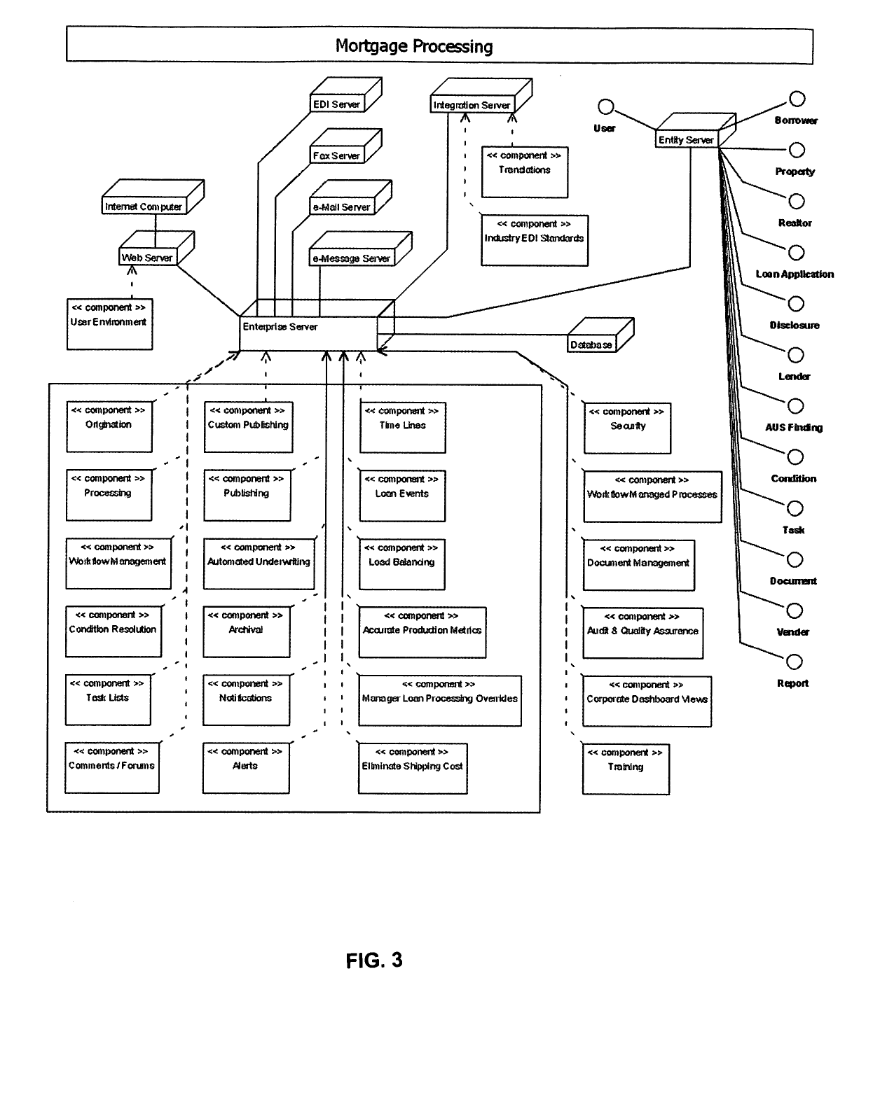

FIG. 4 illustrates a system architecture in accordance with a embodiment of the invention related to real estate transaction processing; and,

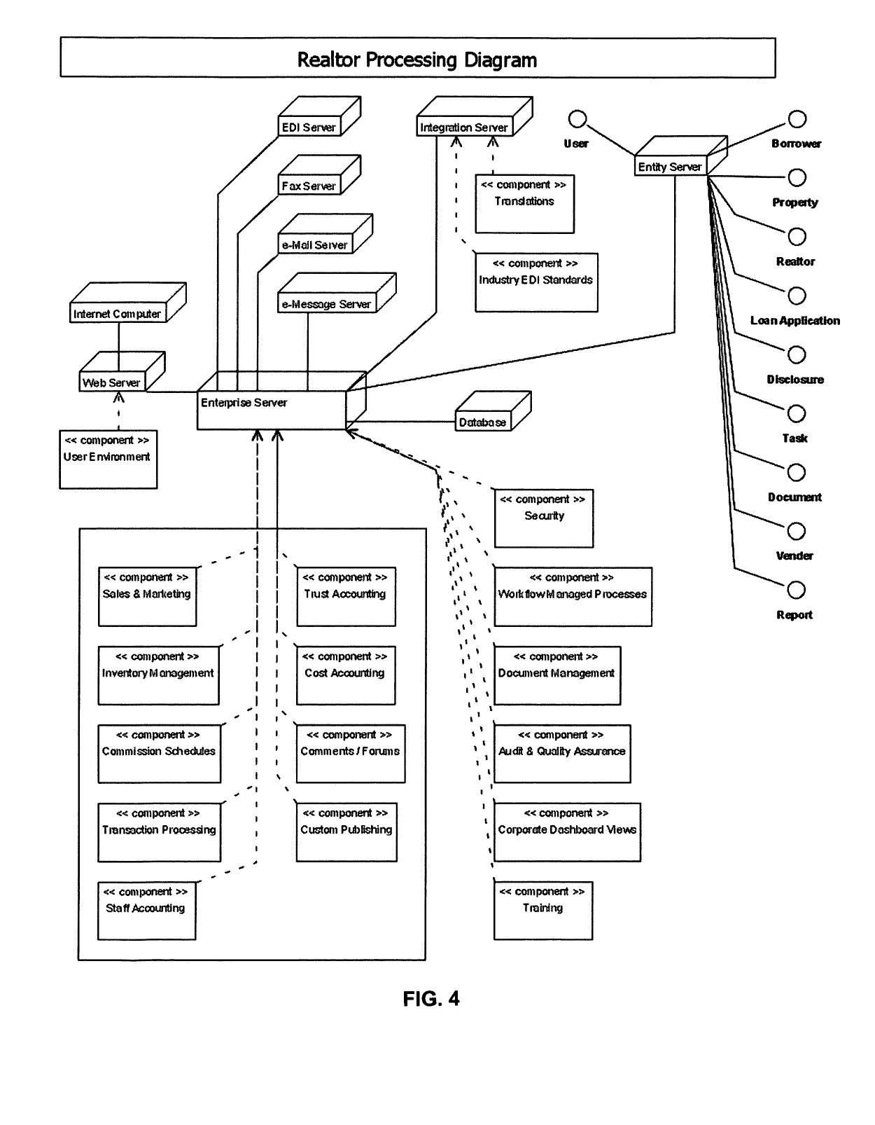

FIG. 5 illustrates a system architecture in accordance with a embodiment of the invention related to underwriter transaction processing.

### DETAILED DESCRIPTION OF THE INVENTION

An embodiment of the present invention discloses a method to provide a financial transaction due diligence convergence platform comprising the steps of:
validating users' credentials;
validating permissions based upon the type of transaction and the role of the users; validating rules based upon the transaction profile and status;
creating a workspace template for transaction;
delivering the template to the users.

The following paragraphs generally outline the steps above using a loan transaction as one example of many financial transactions contemplated by the present invention.

Validate user credentials including assigned account. A user is granted access to the system only after the user submits their credentials and their credentials are validated. Typically this includes the user's code, password, and account identifier. The common “logon” screen is such a mechanism. In the examples below a user may represent multiple roles. Thus a single user, although unlikely, may work a loan application through the complete loan process.

Validate permissions based upon account, role, and user. The permissions for all interaction between the user and the system if configured by the user's administrator. Loan content is displayed if the user has permission to view the loan content. Menu access and screen navigation is visible and enabled only if the user has permission to access these features. Information updates and services are available only if the user has permission to perform these features.

Validate rules based upon loan profile and status. Industry and client specific business rules are applied to a loan's profile and a loan's work flow “migration” path. This is typically called business logic and is defined and managed within the system. Each role has a subset of control over how the system applies the business rules to the processing of individual loans, loan types or by location/work group.

After the user successfully logs onto the system a workspace is opened for the user. The user is presented with a workspace that provides the most appropriate environment to the user to perform the required work needed to fund the loan. A user can preset personal workspace options, default input tables and features. New workspaces can be configured by the client. All appropriate aspects of a loan are visible in each of the workspaces.

After a loan application is imported or created in the system, its interaction with the users can be configured by loan managers. This configuration includes: users which have access to the loan; user's permissions of interaction with the loan; migration path between accounts and users. As a loan application is worked it migrates from account to account, user to user, production stage to production stage; and, requirements for the loan's conditions, tasks, documents, certificates, and other matters as needed.

Delivering the workspace templates to users. After the user successfully logs onto the system a workspace is opened for the user. The user is presented with a workspace that provides the most appropriate environment to the user to perform the required work needed to fund the loan. A user can preset personal workspace options, default input tables and features. New workspaces can be configured by the users. All appropriate aspects of a loan are visible in each of the workspaces.

Workspace templates are selected from a group comprising of, but not limited to, loan services, underwriting services, lender services, real estate services, investor services, document management services, integrated services, and audit services.

### EXAMPLE 1

### Loan/Lender Services

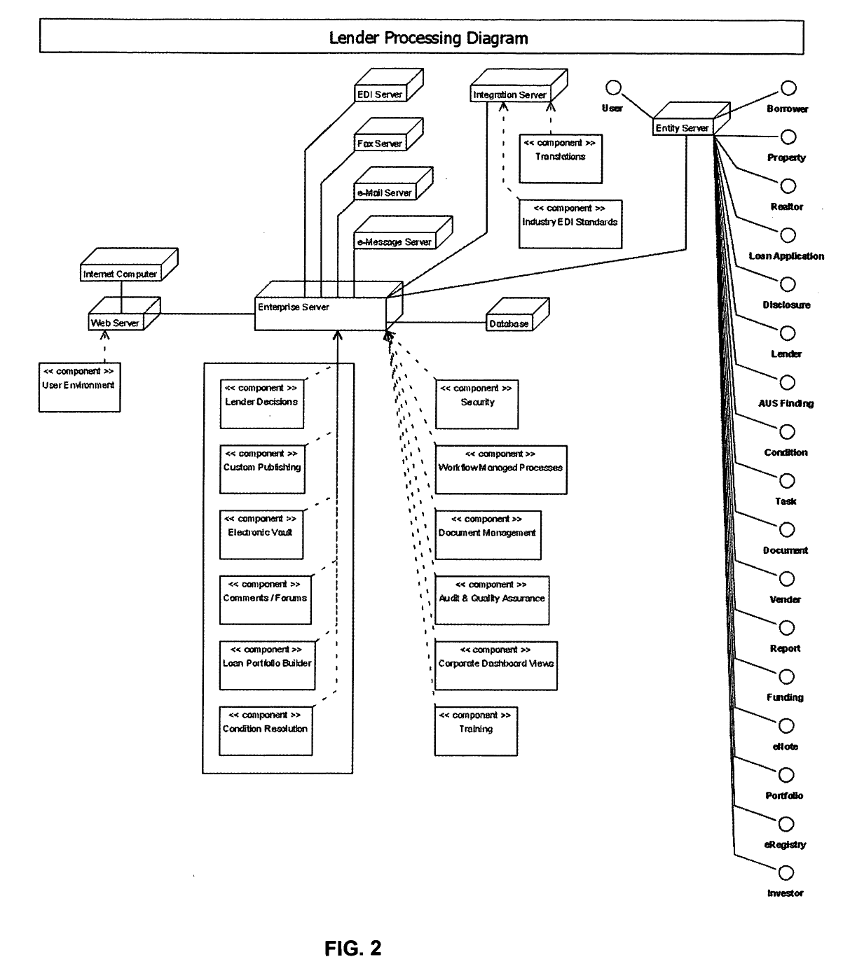

See FIG. 2. The loan officer consults a borrower for a mortgage loan program. After the loan program is selected the loan officer enters the borrower and property information into the loan application electronic form. The loan officer prints facsimile cover sheets that direct the borrower for which documents to fax into the system and its fax phone number. The officer submits the loan application to processing.

The next available loan processor selects the new loan application and chooses to work the loan application. An “underwriting response” of the loan can be requested from one of the major GSE companies, Freddie Mac/Fannie Mae.

The loan processor faxes the initial disclosures with facsimile cover sheet to the borrower. The loan officer is automatically notified to call the borrower for disclosure consultation. The borrower signs and faxes the disclosures into the system.

The loan processor uses the electronic “To Do” list and begins to resolve the loan's conditions as stated in the “underwriting response” and predefined business rules. The loan processor request reports and services. The system electronically orders the requested the reports and services from the appropriate entities. The processor verifies the faxed document's content matches their auto assigned classification and the document's corresponding values prove the loan applicant's statements are factual. A login user is created for the borrower. The processor submits the resolved loan application to their manger or underwriter.

The loan processor's manager is notified of the new loan application for approval. The manager reviews the loan application. Once approved the loan is submitted to underwriting. A manager may or may not be included in a loan's process. The client uses the system workflow manager to configure loan routing.

This process involved no hard copies or couriers and required no verbal interaction between employees working on the loan. Each employee can reside anywhere their computer can communicate with the Internet. A “running” commentary for the loan is managed in an electronic forum. All responsible parties can view the loan's status and timeline in real time electronically. The system monitors the loan and alert/messages are triggered for circumstances that should be addressed or reported.

This example of the present invention contemplates that loan services include the following functionalities:

1. Origination. The loan application is electronically created on the system. This can be performed using an on-line form or an EDI interface with an external system. Initial fiscal and demographic borrower details are entered and selected. Work flow tasks, conditions, events, and timelines are established. The upfront disclosures are made ready for signature and then signed.

2. Processing. Work flow tasks, conditions, events, and timelines are established upon the origination of a loan. The loan program and lender's product is selected. The disclosures are made ready for signature and then signed. The automated underwriting response is performed. Processing is complete when the loan is ready to be submitted to the Underwriter.

3. Workflow Management. Work flow of a loan and its workers is managed and maintained by the system. The work flow is configured by managers and/or administrators. Examples of loan work flow include loan file routing, automated decisions and condition resolution, work flow profile at the loan level, required acknowledgments, and manager approvals. Well configured work flow parameters stream line the loan process reducing processing effort and time.

4. Condition Resolution. The automated underwriting response establishes the required conditions to be resolved and/or documented. Industry and client specific business rules are also used to establish required conditions. The resulting loan condition list is typically resolved when processors provide documents of proof and/or visual verifications.

5. Task Lists. Program and lender's product types determine a loan's required tasks. Industry and client specific business rules are also used to determine required tasks. The processor typically performs these tasks.

6. Comments/Forums. While working a loan, user's comments are managed in an electronic forum. Comments are messages sent to other users who have access to the loan. The comment display with a timestamp of its creation. Comments can be marked with restrictive access. Comments marked with restrictive access are accessible only in the loan processing workspaces. The underwriter and lender workspaces will not be able to access restricted comments.

7. Custom publishing driven by underwriter options. Each underwriter requires a specific subset of loan documents, disclosures, and reports. Each underwriter also requires these documents to be “stacked” in a specific order. As a loan is published or routed to an underwriter, the system will automate the building of a loan package with the underwriter's specified content and stacking order.

8. Publishing. Loan publishing is used to deliver a loan package to external systems while preserving the loan's original content and image as best is possible. The output format of the loan package varies according to the media being used to deliver the loan package. The system is able to publish in many different presentations forms and media formats. Publishing differs from external interface services. Publishing a loan package usually involves the complete loan as a whole unit. While external interfaces usually involves a subset of one or more loan packages and or documents. A loan may be published as a PDF or XML document, sent to a facsimile machine, or transmitted by secure internet communications like SSL e-Mail. It may also be exported into a file formatted to a client's specifications. The PDF format is also viewable on-line and supports local printing.

9. Multiple Automated Underwriting. One or more underwriting responses are displayed for each loan. A processor will typically only work the underwriting response that suggests the easiest path to funding. The user determines which underwriting response to work by activating a single response. Each response contains its own work flow tasks, conditions, events, and timelines. The system calculates the percentage of success for each underwriting response. The user can use this information when choosing which underwriting response on a loan to work.

10. Loan Package Archival. The loan package is available for archiving after automated underwriting. The loan package can be tamper sealed. The loan package is stored on media appropriate for archiving at redundant, remote locations. The loan package is available for retrieval for purposes of viewing and restoring working data. The loan package is stored in data format that can be translated to newer/other data formats. Thus the loan packaged data is secured and preserved in time and guaranteed to be restorable in future versions of data formats.

11. Rules Based Alerts & Notifications. The status of a loan application changes as it is worked. The status changes are monitored by automated systems. The automated systems are configured to deliver messages when they are triggered by the status changes. Automated alerts or notification messages of loan events for individual loans, all loans in an account, or select loans or groups of loans matching customized criteria can be delivered to one or more recipients via email, fax, or both. Client specific configurations create unique criteria for each trigger. This feature is to be used as an internal management and communication tool with loan customers and external entities or persons.

12. Time Lines. Loan applications usually expire within a specified frame of time. Rate locks and loan product features are examples of loan elements that are bound to time frames. Thus it is critical that the loan processor be made aware of these time frames and warned of their expiration. Each workspace contains visible controls that indicate the appropriate time lines on any given loan.

13. Tracking of external loan events—manual or synchronized to external systems. The system is informed of external events that influence a loan's time line by automated electronic synchronizations or by the user manually updating the system with events, dates, or status changes. A manual update includes a user setting indicators and/or dates in the system. This manual update may be related to loan processing transactions that have occurred outside of or external to our system. The external system may have not communicated electronically with our system. Since the user has knowledge of the transaction, it is acceptable that the user manually update our system of the transaction event. An automatic update includes an external system informing our system of a loan processing transaction that occurred outside of or external to our system. If the external system has knowledge of the transaction, it is acceptable that the external system automatically communicate electronically update our system of the transaction event.

14. Automated work assignments/load balancing/condition alerts. Work assignments are managed and configurable by management. As a loan officer's work load reaches its maximum work level, new loans are deferred to the next available user. Condition criteria can be defined by management. When these conditions are found during routine automated query analysis, electronic alerts are sent to the appropriate, configured manager or resources. Management actively participates in resolving work flow or production issues.

15. Accurate Production Metrics. Loan transactions/movements are accurately recorded where production reports can be reviewed. As loan applications are funded, the institutions involved in the loan's processing are notified of it completion. The system does not promote misrepresented productivity.

### EXAMPLE 2

### Underwriting Services

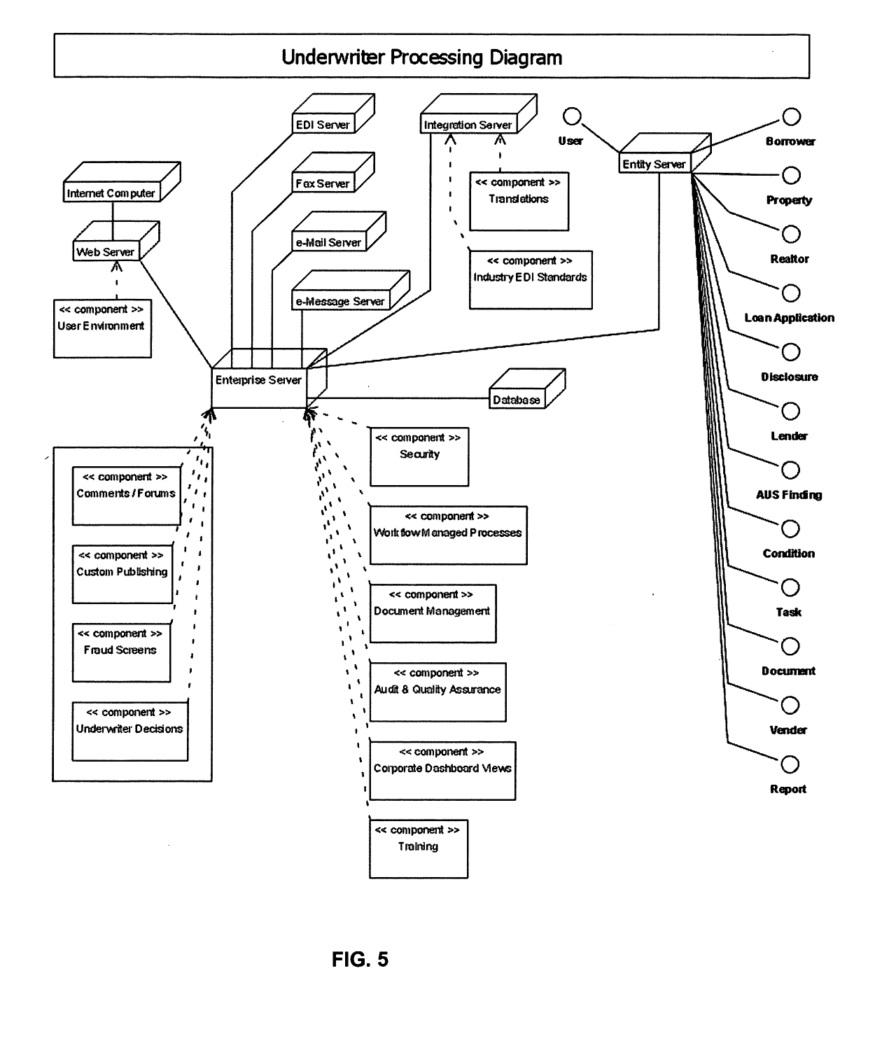

See FIG. 5. The underwriter is automatically notified of new loan packages ready for underwriting. The underwriter reviews the loan package. The loan officer decides to counter the loan offer, suspend the process with further conditions, deny the loan out right, or accept the loan as is. If accepted the loan is submitted to the lender for funding. Underwriter services include the following:

1. Underwriter Decisions. Underwriting decisions include accept, counter, suspend and denial of loan applications. When an underwriter decides to counter, suspend or deny a loan application, comments or clarification is entered by the underwriter and passed back to the appropriate loan processing member or institution.

2. Custom publishing driven by lender options. Each lender requires a specific subset of loan documents, disclosures, and reports. Each lender also requires these documents to be “stacked” in a specific order. As a loan is published or routed to a lender, the system will automate the building of a loan package with the lender's specified content and stacking order.

3. Underwriter Forum. Comments and notes can be segregated where only the underwriter workspaces can access the forum. All normal forum features are supported as well.

4. Fraud Screens. Loans are electronically validated for authenticity and accuracy before funding is considered by the lender party. Client specific business rules and/or external third party tools and components can be applied to the fraud evaluation.

All of the above “Loan Services”, in Example 1, can apply to the underwriter's workspace. Conditions, tasks, documents, events and time lines are adjusted where appropriate.

### EXAMPLE 3

### Lender Services

The lender is automatically notified of new loan packages ready for funding. The lender reviews the loan package. The lender uses the electronic “To Do” list and begins to resolve the loan's conditions that need to be satisfied before documents are drawn. After which the documents are ordered and drawn up. The underwriter uses the electronic “To Do” list and begins to resolve the loan's conditions that need to be satisfied before funding is initiated. After which the loan packaged is funded.

The underwriter uses the electronic “To Do” list and begins to resolve the loan's conditions that need to be satisfied before the loan is finally closed. After which the closing documents are ordered and a check is signed. Lender services include the following:

Lender Decisions. A lender has the same opportunity to make the same decisions as the Underwriter makes. (An Underwriter is usually a representative of a lender's office.)

Custom Publishing. Each investor requires a specific subset of loan documents, disclosures, and reports. Each investor also requires these documents to be “stacked” in a specific order. As a loan is published or routed to an investor, the system will automate the building of a loan package with the investor's specified content and stacking order.

Electronic Vault Service. An electronic vault service provides secure and reliable online data backup and recovery services. Loan packages are backed up and moved off-site to a secure facility. If data loss or catastrophe should strike, rapid and accurate restoration is performed to return the system back to a complete state.

Lender Forum. Comments and notes can be segregated where only the lender workspaces can access the forum. All normal forum features are supported as well.

All of the above “Loan Services” in Example 1 can apply to the lender's workspace. Conditions, tasks, documents, events and time lines are adjusted where appropriate.

### EXAMPLE 4

### Document Management Service

The paper trail of a completed loan package can be extensive and several inches thick. The system reduces the hard copies and shipping costs. Loan disclosures and supporting documents such as the tax forms and employment papers can all be faxed into the system. With electronic signatures the borrower no longer needs to sign a physical piece of paper. This can be performed over the internet or a “signing kiosk”.

The system supports the facsimile and can be used to import any existing hard copy document into a loan package. All documents received with corresponding white sheets are automatically indexed appropriate loan files. When documents are indexed to a loan, automated condition resolution is performed. The loan processor needs only to visually verify the documents for authenticity and correctness.

Where appropriate electronic documents can be optically scanned for required field values (these values are used as input for automated form completion). Using computer scanner devices and web browser, an imaging workstation can be created to provide a high speed document imaging processing station. This provides a highly adaptive environment with increased production and reduction of costs and time.

For a correctly configured environment and fundable loan application and underwriting response, a loan processor can literally refresh his browser screen and watch a loan complete itself. Since all documents are electronic the cost for storage space is removed.

Document management services may also include: automated document indexing of facsimile and scanned documents; import document files; upload documents into a loan's work folder via a secure link or facsimile; loan condition and task assignments; marking documents as associated to a loan stage or as a supporting document; if the document is supporting loan conditions, then automatically assign the document to one or more conditions or tasks found on the loan; identification or classification; split, merge and group documents; and publishing or communicating documents.

### EXAMPLE 5

### Integrated Services

During the loan process numerous services need to be requested and documents filed for retrieval that include but are not limited to home owner insurance, pest inspection, house appraisal, entitlement, and insurance certificate copies. With proper relations and connections, these services and fillings can be performed at the click of a button.

Since the documents and service reports are received as electronic documents, the “To Do” list is automatically managed. Loan status reports are available in real time with a real time status. Also third party businesses can offer extended services, such as metadata or special procedures. Also security can be greatly increased using electronic ciphering and strong security standards that can far exceed today's typical usage of e-Mail and uncredited delivery workers.

As new and better forms of business become established, such as MERS, MISMO & SISAC, the system has leveraged itself to adapt to these new standards. Because the system is using open technology there is a greater support for new business to business relationships.

Integrated services may include: import existing loan files; automated underwriting; credit reports, appraisals, fraud investigations, flood insurance requirements, environmental reporting; and managing all reports required to resolve a loan application. The credit report documents are attached to a loan; viewed, validated and worked as any other document in a loan folder.

### EXAMPLE 6

### Audit and Quality Assurance Services

The system provides audit trails of all changes performed on a loan within the system. The client can request that, prior to any changes in a loan, the loan information is backed up, and creating managed versions of the loan information. Thus changes to a loan can be reported and evaluated where needed.

Using industry and client specific business logic, loans are automatically evaluated for quality assurance and quality checks. The loans are rated accordingly and reports can be created for the purpose of quality assurance. These reports also describe the state of difficulty required for each loan to become successfully funded.

Audit & quality assurance services may also include: audit trail for every processed transaction including user name, time stamp, and action performed; Loan data, status, & documentation can be versioned off into a retrievable datasets for future receipt or comparisons; and, timely loan quality control checks are automatically performed on data sources.

Additionally included are checks for data reasonableness, trends, variances, ratios, and industry standards. Checks for lost or orphaned loans, dead end loan routing, cyclical loan routing, skipping, or overrides of checks and balances and security breaches are also contemplated by the present invention. Continuous data integrity checks are performed on persisted data. Abnormalities and exceptions are reported. Proactive services are initiated in order to repair or update inconsistent data.

### EXAMPLE 7

### Investor Processing—Discussion Topics

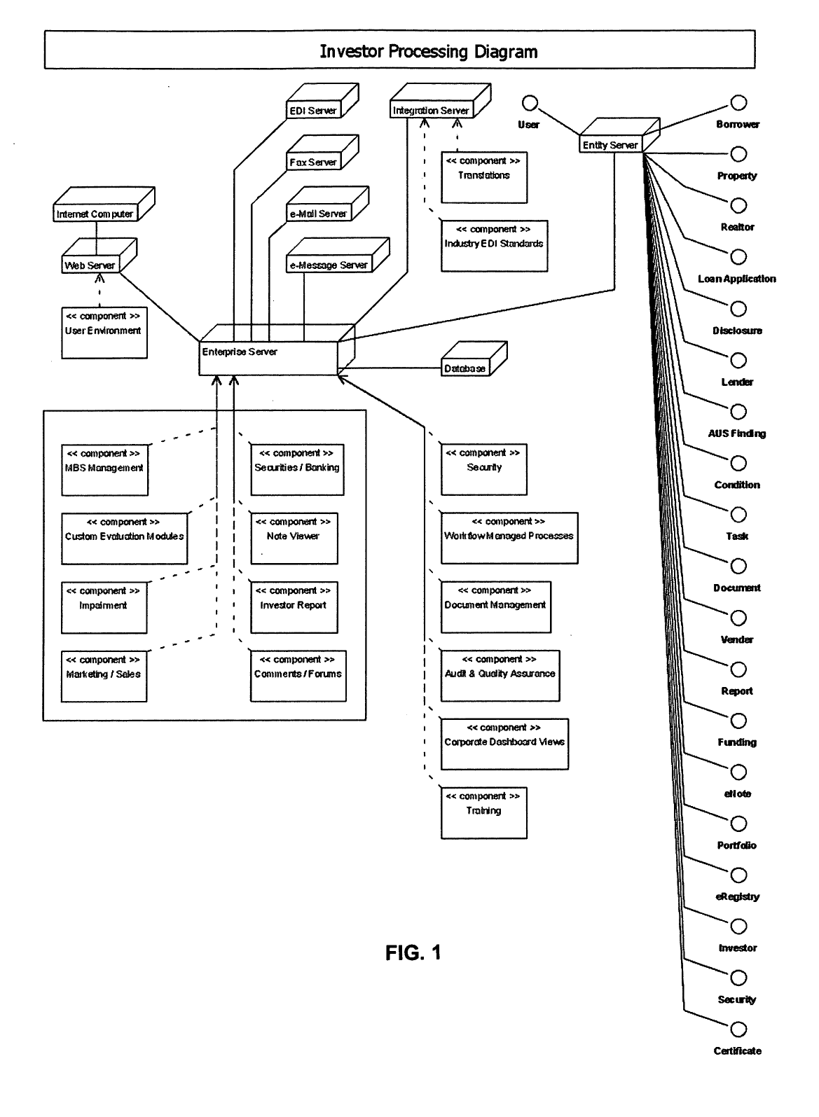

Non-limiting reference to FIG. 1. The servers, components and entities are organized as shown in FIG. 1 and deployed on one or more computers where the result is a robust system able to perform the requirements/claims as described in the “Loan Services” of Example 1. FIG. 1 is a typical representation of the said system. The system may include other proprietary services, external connectivity, security, redundancy, fail over services, backup sites, and support for other presentation outputs.

Functionalities included are: presentation includes interacting web pages, publications, and EDI interfaces; business services and transactions are represented by the software components; and the information is stored on the Database.

The Web Server renders the presentation and manages the connected users' session. The User Environment component supports the user's environments. The Enterprise Server manages the software components below it. The Entity Server manages the entities. Each type of entity has a unique identifier (UID). The entities are managed so that no entity with the same UID may be duplicated within the system.

The Database manages the persisted data source. The EDI, Fax, e-Mail, e-Message, Integration servers manage there appropriate resources and services.

The software components in the box are specific to FIG. 1. The software components outside of the box are not specific and universally support the overhead requirements of the system.

Some software component's names are duplicated across diagrams. They are similar in function yet they are unique for each system as each system contains a unique set of defined business rules. The investor business rules are different from the realtor's business rules. Each component in each of the processing systems diagrams are unique code sets.

The investor processing software components support all of the necessary functions as described in Example 1. A software component executes in a run time environment which executes in a computer. A server executes in a computer. A computer can contain one or more servers. A run time environment may contain one or more software components.

The computers in FIG. 1 are not shown and assumed to exist for the effect of simplicity and clarity. Furthermore a server communicates with other servers using a computer network. The lines between servers without arrows represent a form of communication. Therefore a server may communicate with another server either internally on the same computer or externally across the computer network. An entity is a specialized software component and also executes in a run time environment.

### EXAMPLE 8

### Figure Elements—Discussion Topics

Non-limiting referral to FIG. 2 thru FIG. 5. The servers, components and entities are organized as shown and deployed on one or more computers where the result is a robust system able to perform the requirements/claims as described in the “Loan Services” Example 1. The system may include other proprietary services, external connectivity, security, redundancy, fail over services, backup sites, and support for other presentation outputs.

Functionalities included are: presentation includes interacting web pages, publications, and EDI interfaces; business services and transactions are represented by the software components; and the information is stored on the Database.

The Web Server renders the presentation and manages the connected users' session. The User Environment component supports the user's environments. The Enterprise Server manages the software components below it. The Entity Server manages the entities. Each type of entity has a unique identifier (UID). The entities are managed so that no entity with the same UID may be duplicated within the system. The Database manages the persisted data source.

The EDI, Fax, e-Mail, e-Message, Integration servers manage there appropriate resources and services. The software components in the box are specific to the specific figure cited. The software components outside of the box are not specific and universally support the overhead requirements of the system.

Some software component's names are duplicated across diagrams. They are similar in function yet they are unique for each system as each system contains a unique set of defined business rules. The lender's business rules are different from the realtor's business rules. Each component in each of the processing systems diagrams are unique code sets. The software components support all of the necessary functions as described.

A software component executes in a run time environment which executes in a computer. A server executes in a computer. A computer can contain one or more servers. A run time environment may contain one or more software components.

The computers in the diagrams are not visible and assumed to exist for the effect of simplicity and clarity. Furthermore a server communicates with other servers using a computer network. The lines between servers without arrows represent a form of communication. Therefore a server may communicate with another server either internally on the same computer or externally across the computer network. An entity is a specialized software component and also executes in a run time environment.

The preceding examples were given as written illustrations of non-limiting embodiments of the present invention. One skilled in the art can appreciate the scope of the present invention.

By providing the various embodiments of the present invention, the ability to deliver a loan transaction package electronically, users can save potentially 3-15 days in the due diligence process. This time estimate is based on a standard package using the traditional method of delivering packages via TransBox or external parcel shipping service. Packages can be delivered up to 5 times, not counting for packages that are sent back due to errors or incomplete packages. Ability to process loans quicker and more efficiently through the use of collaborative platforms and event driven workflows are results of the use of embodiments of the present invention. Functionalities include:

1. Real-time notifications based on event driven workflow. For example, email notification of incoming documents, allowing the processor to focus on processing loans rather than tracking down supporting documents.

2. Centralized data and document management for loan processing. For example, system level controls based on workflow engine to allow multiple parties to view the loan and only one party to modify the loan based on Stage, Status and Role.

3. Visual representation of the underwriting findings and the supporting documents that support each and/or all findings. For example, allowing any user to work the file and not have to review the file prior to working the file. From the underwriting findings (Freddie Mac and Fannie Mae) the user can see the findings, 1003 data associated with the findings and the supporting documents associated with the findings. This allow file to be worked from one screen various the traditional method of multiple screen or a desk full of documents.

4. Automated document assignment to underwriting findings based on custom rules engine. Documents are assigned to the appropriate finding based on document name and tag. Allowing the processor to simply review the file and approve the assignment, rather than having to interrupt the file and documents to determine their assignment.

5. Automated assignment of faxed document to the loan package, pre tagged and indexed. Thus, providing custom coversheets that associate the document name, loan file and account ID to index the documents. User can submit multiple files in an individual fax transmission using their current fax machine.

6. Audit trail of all transaction and electronic-Quality Control checks within the system, showing user, date, time, transaction and comments.

Unless otherwise indicated, all numbers expressing quantities of ingredients, properties such as data, database parameters, reaction conditions, and so forth in the specification and embodiments are to be understood as being modified in all instances by the term “about.” Accordingly, unless indicated to the contrary, the numerical parameters set forth in the specification are approximations that may vary depending upon the desired properties sought to be obtained by the present invention. At the very least, and not as an attempt to limit the application of the doctrine of equivalents to the scope of the embodiments, each numerical parameter should at least be construed in light of the number of reported significant digits and by applying ordinary rounding techniques.

Notwithstanding, numerical ranges and parameters setting forth the broad scope of the invention are approximations, the numerical values set forth are reported as precisely as possible. Numerical values, however, inherently contain certain errors necessarily resulting from the standard deviation found in their respective testing measurements.

The terms “a” and “an” and “the” and similar referents are used in the context of describing the invention and are to be construed to cover both the singular and the plural, unless otherwise indicated herein or clearly contradicted by context. Recitations of ranges of values herein are merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all definitions, examples, or exemplary language (e.g. “such as”) provided herein is intended merely to better illustrate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended embodiments.

Preferred embodiments of this invention are described herein, including the best mode known to the inventors for carrying out the invention. Of course, variations on those preferred embodiments will become apparent to those of ordinary skill in the art upon reading the foregoing description. Accordingly, this invention includes all modifications and equivalents of the subject matter recited in the embodiments appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

In addition, the embodiments of the present invention, without limitation, can be used in research, product manufacturing, and data access systems or used calibration systems as in accordance with the appropriate research, clinical trial, manufacturing or treatment protocols or procedures approved by the appropriate governing institutions having authority to recommend, approve, evaluate or regulate such protocols or procedures.

1. A method to provide to provide a financial transaction due diligence workplace platform comprising the steps of:
selecting at least one financial transaction;
validating at least one user's credentials;
validating at least one set of permissions based upon the type of transaction and the role of the users;
validating at least one set of rules based upon at least one selected financial transaction profile and status;
creating at least one workspace template for the at least one selected financial transaction;
delivering the at least one workplace template to at least one validated user.

2. The method of claim 1 wherein said at least financial transaction is selected from the group consisting of asset based lenders, personal loans, real estate loans or transfers, mortgages, insurance policies, investments, appraisals, stock trades, auctions, technology transfers and derivatives or combinations thereof.

3. The method of claim 1 wherein said delivering step further comprises the electronic transmission of the said at least one workspace template utilizing a network of computers accessible to by at least one validated user.

4. An article of manufacture having stored thereon at least one executable software program operative to effectuate the processing of financial due diligence for financial information in connection with at least one financial transaction, wherein the executable program is executed to, perform the steps of:
selecting at least one financial transaction;
validating at least one user's credentials;
validating at least one set of permissions based upon the type of transaction and the role of the users;
validating at least one set of rules based upon at least one selected financial transaction profile and status;
creating at least one workspace template for the at least one selected financial transaction;
delivering the at least one workplace template to at least one validated user.

5. The article of manufacture of claim 4 wherein said at least financial transaction is selected from the group consisting of asset based lenders, personal loans, real estate loans or transfers, mortgages, insurance policies, investments, appraisals, stock trades, auctions, technology transfers and derivatives or combinations thereof.

6. The article of manufacture of claim 4 wherein said delivering step further comprises the electronic transmission of the said at least one workspace template utilizing a network of computers accessible to by at least one validated user.
